(19) United States
(12) Patent Application Publication
(10) Pub. No.: US 2006/0144708 A1
(43) Pub. Date: Jul. 6, 2006

(54) In-gel fluorescent protein staining technique

(76) Inventors: Jeffrey Kitzler, Decatur, GA (US); David Werner, Stockbridge, GA (US); Abdul Ibrahim, Marietta, GA (US)

Correspondence Address: Rohm & Monsanto, 12 Rathbone Place, Gross Pointe, MI, 48230, US

(21) Appl. No.: 10/532,403

(22) PCT Filed: Oct. 23, 2003
(86) PCT No.: PCT/US03/33819

§ 371 Date: Feb. 13, 2006

Related U.S. Application Data
(60) Provisional application No. 60/421,021, filed on Oct. 23, 2002.

(51) Int. Cl. B01D 57/02; B01D 59/42

(52) U.S. Cl. 204/461; 204/468

(57) ABSTRACT

An “in-gel” staining technique for detecting and/or separating proteins during electrophoresis, illustratively as a modification of the standard Laemmli procedure. A fluorescent dye, such as Nile red or Phosphine, is included in the running buffer (mobile phase) which may be a standard Laemmli Tris-Glycine SDS buffer that has been modified to reduce the concentration of detergent (SDS) to less than the typical concentration (0.10% v/v). The fluorescent dye stains proteins during electrophoretic separation. The post-electrophoretic operations are, therefor, reduced and the separated, stained fractions are recoverable for further processing, purifying or analysis.

### CROSS-REFERENCE TO RELATED APPLICATIONS

This application claims the benefit under 35 U.S.C. § 119(e) of U.S. Ser. No. 60/421,021 filed Oct. 23, 2002. The disclosures of this application is incorporated herein by reference.

### BACKGROUND OF THE INVENTION

1. Field of the Invention

This invention relates generally to a system for detecting proteins by electrophoresis, and more particularly to a system for the staining of proteins with a fluorescent dye during electrophoretic separations.

2. Description of the Related Art

One of the most widely used methods for the separation of proteins is gel electrophoresis. A sample of a protein on an inert support is subjected to an electric field that causes the proteins to migrate in accordance with molecular weight. Typically, the supports are made of polymers, such as polyacrylamide, which is a copolymer of acrylamide and bisacrylamide, or agarose, a polymer of glucose units. In the most common method of electrophoretic separation of proteins, typically abbreviated SDS-PAGE, proteins are coated with sodium dodecyl sulfate (SDS) and placed in a support of polyacrylamide gel and subjected to an electric field. However, the separated proteins are not generally visible to the naked eye. Therefore, the bands or spots must be stained with a dye. Some of the most commonly used dyes for visualization are Coomassie blue, Fast green, and silver stains.

The separated protein bands or spots may also be visualized by labeling with a fluorophore. In this procedure, the gel is stained with a fluorescent dye, such as ethidium bromide, and illuminated by a light source that is capable of exciting the dye-protein complex in the sample with light at or near the wavelength of the maximum absorbance of the dye-protein complex. The ultraviolet excitation of known dyes typically occurs between about 254-370 nm, while visible excitation occurs at 490-550 nm.

In order to stain, the gel support is first immersed in a solution of the dye and then washed, rinsed, or subjected to some other procedure, to remove the dye from those regions of the support that do not contain protein. The sensitivity of the method of detection depends, among other factors, on the affinity of the dye for the protein and on the difference in visibility between the stained protein regions and the support. The difference in visibility often depends on how well the gel is destained but excessive destaining can result in loss of the protein band signal. Moreover, the post-electrophoresis manipulation of the gels for staining and destaining is inconvenient and costs time and money. There is, therefore, a need for an improved method of staining protein bands fractionated by electrophoresis.

In addition to the foregoing, the staining and destaining techniques subject the protein sample to undesirable conditions, such as acidic pH levels or organic solvents. Therefore, the known methods typically preclude blotting the protein from the gel for subsequent immunoanalysis or recovery of separated proteins for subsequent analysis by mass spectrometry or other methods. There is, therefore, a need for an improved method of visualizing proteins fractionated by electrophoresis or other methods in inert gel supports that permits subsequent processing or analytic techniques.

In one known method for staining proteins in SDS-PAGE gel, the dye Nile red is used as a post-electrophoretic fluorescent stain. See, Daban, et al., Anal. Biochem., Vol. 199, pages 162-168 (1991). Advantageously, Nile red can be used as a stain without fixing the gel prior to staining, and therefore, the resulting stained gels can be blotted for further analysis. However, Nile red is substantially insoluble in aqueous solutions, resulting in a staining solution that has a useful life of about 1-5 minutes. In addition to increasing the difficulty of handling, the reproducibility of results from lane to lane, and from gel to gel, is negatively impacted. There is, therefore, a need for an improved method of staining gels that is more convenient and reproducible.

It is, therefore, an object of this invention to provide an improved method of staining protein bands fractionated by electrophoresis that is less expensive and time-consuming, as well as more convenient, than the known post-electrophoretic staining techniques.

It is further an object of this invention to provide an improved method of staining protein bands fractionated by electrophoresis that yields results that are reproducible from lane to lane, and from gel to gel.

It is also an object of this invention to provide an improved method of staining protein bands fractionated by electrophoresis that permits better recovery of the separated proteins and is conducive to further processing or analysis of the separated proteins.

### SUMMARY OF THE INVENTION

The foregoing and other objects, features, and advantages are accomplished by this invention which is a novel method of staining proteins during electrophoresis, herein referred to as “in-gel” staining. The method is a modification of the standard Laemmli procedure and, therefore, is readily incorporated into existing protocols. The Laemmli procedure is described, for example, in Nature, Vol. 227, pages 680-685 (1970), the text of which is incorporated herein by reference.

In a broad method embodiment for detecting and/or separating proteins by gel electrophoresis, a sample mixture is prepared in any known manner. Typically, the sample is dissolved or dispersed in water or an aqueous buffer. A detergent, which may be any amphiphilic surface active agent, or surfactant, that can coat or otherwise associate with the protein surface, is added to the sample mixture. In the preferred SDS-PAGE method, of course, the surfactant is sodium dodecyl sulfate.

The sample mixture is placed on an inert polymeric gel support matrix of the type used for gel electrophoresis by any known method and is subjected to an electric field, in the presence of a running buffer, to separate proteins in the sample into discrete bands based on molecular weight. In the standard Laemmli procedure, the running buffer (mobile phase) comprises an aqueous solution of 0.025 M Tris (tris(hydroxy methyl)amino-methane) and 0.192 M glycine at about pH 8.3. The running buffer also includes about 0.10% (v/v) or more SDS. However, in the method of the present invention, the running buffer includes a fluorescent dye and the concentration of SDS, in preferred embodiments, is less than the typical 0.10% v/v concentration used in the original Laemmli procedure. In preferred embodiments, the concentration of SDS is 0.075% v/v or less, and most preferably 0.05% v/v. As a result, the proteins in the sample mixture are stained as they separate into discrete bands based on their molecular weight.

During electrophoresis, the dye is carried into the gel in complex with the anionic SDS, and may possibly accumulate in protein-SDS complexes. After electrophoresis, bands containing as little as 250 ng of protein may be visualized by observing the gel under UV illumination (302 nm). Any illumination device, which is capable of emitting light at wavelengths in the ultraviolet and/or visible regions, illustratively a transilluminator, arc lamp, or laser, may be used in the practice of the invention. Sensitivity is improved dramatically by “destaining” the gel.

In a preferred method embodiment, destaining comprises washing the gel with water, preferably twice, with two 15 minute rinses. After destaining the gel, background fluorescence is nearly completely eliminated, and bands containing amounts of protein as low as 10 ng have been observed.

Although the step of washing has been termed “destaining,” there is strong evidence to suggest that the dye remains in the gel and only free SDS is washed out of the gel during the water washes. However, if this is the case, the dye may not be fluorescent in the absence of SDS. Of course, the protein-SDS complexes do not dissociate during the wash steps, so that these regions of the gel remain fluorescent.

In an alternative embodiment of the invention, the destaining solution contains potassium chloride (KCl), and preferably is a 0.1M solution of KCl in deionized water.

The destaining protocol remains the same in this embodiment. The stained protein bands may be preserved in this destaining solution for 12-16 hours at room temperature with only a slight loss in sensitivity. In order to preserve the stained gel for a longer period time, the gel may be immersed in an aqueous solution of 0.5 M potassium chloride after the first 30 minutes of destaining.

Since staining occurs during the run, post-electrophoretic manipulations of the gel are minimized. As compared to the standard Coomassie staining technique, the system of the invention reduces post-electrophoretic process time from 4-8 hours to 30 minutes. When compared to existing fluorescent protein stains, the inventive system is generally faster and substantially cheaper.

The non-denaturing aspect of the stain allows proteins to be recovered from the gel with substantially improved yields relative to other procedures currently available. For example, the user can recover 50% of the protein simply by elution into water over the course of a two hour time period. The same recovery from a Coomassie stained gel is only possible with electroelution or some other time-consuming and complex technique. The stain does not covalently modify the proteins or alter the electrophoretic pattern of the gel in any way, so recovered proteins are suitable for the widest range of subsequent processing or analytic techniques. Thus, in a particularly preferred embodiment, the method comprises further step(s) of processing, purifying or analyzing a separated protein fraction.

In fact, stained proteins recovered from electrophoretic separation in accordance with the invention are sufficiently pure for analysis by matrix-assisted laser desorption ionization mass spectroscopy (MALDI-MS).

As an example of further processing, stained proteins have been transferred from a gel processed in accordance with the invention to polvinylidine difluoride (PVDF) membranes in a typical Western blotting technique. The dye that transfers to the PVDF gel during blotting can be removed by simply washing the PVDF membrane in methanol, for example, for 1-2 minutes. Transfer of proteins from a gel stained in accordance with the present invention is not inhibited relative to an unstained control.

In a composition of matter aspect of the invention, the running buffer for electrophoretic separation is a detection reagent that will also stain proteins during electrophoretic separation. The detection reagent is an aqueous buffered solution containing a fluorescent dye. A preferred dye for the practice of this invention is Nile Red, CAS# 7385-67-3, also known as 9-diethylamino-5H-benzo(α)phenoxazine-5-one).

Nile red is available through commercial sources, such as Sigma Chemical Company, St. Louis, Mo. As indicated hereinabove, Nile red has been used as a post-electrophoretic stain. However, this is the first known use of Nile red in an in-gel staining methodology.

In an alternative embodiment, the fluorescent dye may be Phosphine, which is available through commercial sources, such as Polysciences Inc., Warrington, Pa., as a mixture of Chrysaniline nitrate and Phosphine E chloride or nitrate. Both Nile red and Phosphine dyes have been used in the art to stain neutral lipids. Neither Phosphine nor Nile Red have been used in an in-gel staining methodology for proteins.

In a specific illustrative embodiment of the invention where the dye is Nile red, the detection reagent, or running buffer, is a modified version of the standard Laemmli Tris-Glycine SDS buffer comprising 0.025M Tris; 0.192 M Glycine; and 0.05% SDS (v/v); and 1 ml of Nile red Dye Concentrate made by dissolving Nile Red (0.5 mg) in a minimal amount of an organic solvent, such as dimethyl sulfoxide (DMSO), dimethyl formamide (DMF) or methanol. The Nile red solution is then diluted into the modified Laemmli Tris-Glycine SDS buffer, and the combination is used as the upper tank buffer, or running buffer, in standard SDS-PAGE electrophoretic separation of proteins.

In preferred embodiments, the remainder of the electrophoresis system, including sample preparation, gel formulation, and lower tank buffer composition, is identical to the standard Laemmli system commonly employed in denaturing protein separations. Of course, the in-gel staining method of the present invention can be adapted to other buffer systems that are compatible with the Laemmli system.

As indicated above, Nile red is substantially insoluble in water and therefore precipitates rapidly from solution. The SDS detergent in the detection reagent of the present invention stabilizes the dye in the aqueous solution giving it a useful life of about 2 hours (as compared to 1-5 minutes for the post-electrophoretic Nile red stain compositions of the prior art). As a result, the detection reagent of the present invention is convenient to use and produces reproducible results from lane to lane and from gel to gel. We have also discovered that, in some embodiments, increasing the amount of SDS detergent in the detection reagent, illustratively to 0.075% v/v, increases the useful life of the detection reagent. In addition to the foregoing, the dye is constantly being replenished on the gel from the upper tank buffer so that staining of the gel is uniform.

The detection reagents, as set forth in the exemplary embodiments disclosed herein, are optimized for staining standard mini-gels run using Laemmli buffer systems, including commercially available gel and buffer systems, such as the ProtoGel system or Protoprep II kit available from National Diagnostics, Atlanta, Ga. It is to be understood, however, that electrophoretic gels, of any size, type or configuration, can be used in the practice of the invention. The gels may be prepared according to standard procedures or may are purchased commercially.

For example, a 20×20 cm gel is typically used for two-dimensional (2D) electrophoresis. The running time is typically 4-6 hours as compared to 2 hours or less for mini-gels (10× cm). In order to increase the useful life of the detection reagent, the amount of detergent in the running buffer is increased to 0.075%. For best results, additional de-staining time is required because the higher concentration of detergent increases background.

Although the description herein is directed mainly to buffer systems that are compatible with the standard Laemmli system, many of the newer pre-cast gels on the market are not compatible with Tris-Glycine SDS. These gels require buffers made with Tris and MOPS (3-[N-Morpholino]propanesulfonic acid) or Tris and MES (2-(N-Morpholino)ethanesulfonic acid) at a neutral pH (about 7.0) rather than pH 8.8 typical of Tris-Glycine SDS buffers. We have found that lowering the concentration of SDS in the newer buffers to 0.05% (v/v) produces good results in the method of the present invention. Thus, the in-gel staining methodology of the present invention can be adapted to other buffer systems.

In a kit embodiment of the invention, a detection reagent concentrate and the 10× buffer concentrate are provided along with instructions for their usage.

Although the invention has been described in connection with detection and separation of proteins, it is to be understood that the principles of the invention can be applied to poly(amino acids), in general, including peptides, polypeptides and proteins. Illustrative sample specimens include enzymes, antibodies, secreted proteins, tissues, and other biological specimens. Of course, the sample will typically contain more than one component.

### BRIEF DESCRIPTION OF THE DRAWING

Comprehension of the invention is facilitated by reading the following detailed description, in conjunction with the annexed drawing, in which:

FIG. 1 is an SDS-PAGE mini-gel stained with Nile red during electrophoresis, in accordance with the principles of the invention.

### DETAILED DESCRIPTION OF THE INVENTION

In a specific illustrative preferred embodiment of this aspect of the invention, a detection reagent (150 ml) is made by diluting 15 ml of 10× Buffer Concentrate to 149 ml with de-ionized water and adding 1 ml of Dye Concentrate, which in this embodiment, contains Nile red.

10× Buffer Concentrate
0.25M Tris (tris(hydroxy methyl)amino-methane)
1.92 M Glycine
0.05% SDS

Nile Red Dye Concentrate
0.5 mg Nile red
1 ml DMSO

In another specific embodiment of the invention, a phosphine dye is used to stain proteins during electrophoresis in SDS-PAGE gels. In this embodiment, the detection reagent is prepared by adding 1 ml Phosphine Dye Concentrate (0.67% dye v/v) to 150 ml of the 10× Buffer Concentrate described hereinabove that has been diluted to 1×.

Phosphine Dye Concentrate
10 mg Phosphine
1 ml water

The following examples illustrate practical embodiments of the present invention.

### EXAMPLE 1

A gel containing the protein specimen(s) is mounted in a standard electrophoresis apparatus. The lower buffer chamber is filled with the 1× Tris-Glycine SDS (0.192 Glycine, 0.025 M Tris, and 0.1% SDS). The upper buffer chamber is filled with the running buffer, which in this case is the detection reagent containing Nile red described hereinabove.

The gel is run under standard voltage and temperature conditions, typically at 175 Volts for 1 hour.

When the gel is removed from the electrophoresis apparatus, the separated protein bands can be visualized immediately using a transilluminator under ultraviolet illumination (302 nm) for the detection of bands containing more than 300 ng of protein. Destaining increases sensitivity. In the preferred method of destaining, the gel is washed, or immersed, in 50 ml deionized water for 15 minutes followed by a second wash in 50 ml deionized water for 15 minutes.

The gel is observed on a transilluminator (302 nm). Protein bands fluoresce yellow-orange. If excessive background is observed, the gel may be washed for an additional 5-10 minutes in a deionized water bath.

If desired, the protein bands may be photographed using a #8 yellow filter of the type used for Coomassie stains. The background fluorescence will increase as the gel is allowed to stand and the surface dehydrates. This background is easily removed with a brief wash in deionized water.

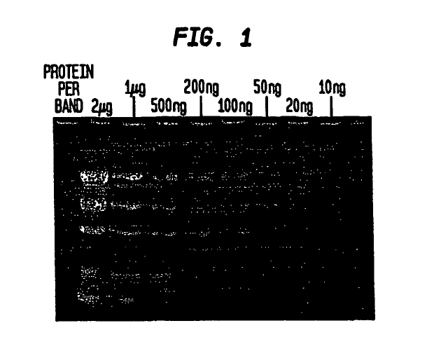

Referring to FIG. 1, various known concentrations of a mixture of bovine serum albumin (BSA), ovalbumin, carbonic anhydrase, trypsin inhibitor, and lysosome were separated by electrophoresis, stained, and visualized under UV illumination, in accordance with the invention. Bands containing as little as 10 ng protein can be seen in FIG. 1.

### EXAMPLE 2

In an alternative embodiment, the destaining solution is an aqueous solution of 0.1 M potassium chloride (KCl). The KCl solution is used in lieu of deionized water in the destaining protocol described hereinbove.

### EXAMPLE 3

In another practical embodiment of the invention, the detection reagent contains a Phosphine dye.

A gel containing the protein specimen(s) is mounted in a standard electrophoresis apparatus. The lower buffer chamber is filled with the 1× Tris-Glycine SDS buffer. The upper buffer chamber is filled with a detection reagent made from the Phosphine Concentrate described above (10 mg Phosphine dye in 1 ml water) added to 150 ml 1× Tris-Glycine SDS buffer.

The gel is run under standard voltage and temperature conditions, typically at 150 Volts for 1 hour.

The gel is destained in 0.0M KCl for 10 minutes and photographed using a UV transilluminator with a green filter.

The detection limit for the technique of Example 3 is between 50 ng-100 ng per protein band.

Although the invention has been described in terms of specific embodiments and applications, persons skilled in the art may, in light of this teaching, generate additional embodiments without exceeding the scope or departing from the spirit of the claimed invention. Accordingly, it is to be understood that the drawing and description in this disclosure are proffered to facilitate comprehension of the invention and should not be construed to limit the scope thereof.

What is claimed is:

1. A method of detecting and/or separating proteins by gel electrophoresis comprising the steps of:
preparing a sample mixture by dissolving or dispersing a protein-containing sample in water or an aqueous buffer;
adding a detergent to the sample mixture to coat or otherwise associate with the surface of protein(s) in the sample mixture;
placing the sample mixture on an inert, polymeric gel support matrix of the type used for gel electrophoresis; and
subjecting the sample mixture on the support matrix to an electric field in the presence of a fluorescent dye in a running buffer having a concentration of detergent less than 0.10%, so as to stain and separate proteins in the sample mixture into discrete bands based on molecular weight.

2. The method of claim 1 gel electrophoresis is standard SDS-PAGE gel electrophoresis

3. The method of claim 1 wherein the detergent is SDS

4. The method of claim 1 wherein the fluorescent dye is selected from the group consisting of Nile red, CAS# 7385-67-3, also known as 9-diethylamino-5H-benzo(α)phenoxazine-5-one). and Phosphine dyes.

5. The method of claim 4 wherein the fluorescent dye is Nile Red.

6. The method of claim 5 wherein the fluorescent dye is a Phosphine dye.

7. The method of claim 1 wherein the running buffer comprises an aqueous solution of 0.025 M Tris (tris(hydroxy methyl)amino-methane) and 0.192 M glycine at about pH 8.3.

8. The method of claim 1 wherein the concentration of detergent in the running buffer is less than 0.075% v/v.

9. The method of claim 8 wherein the concentration of detergent in the running buffer is 0.05% v/v.

10. The method of claim 1 comprising the further step of visualizing the separated protein(s) on the support matrix.

11. The method of claim 10 wherein the step of visualizing comprises:
illuminating the support matrix with UV illumination.

12. The method of claim 10 comprising the further step of:
destaining the gel prior to the step of visualizing.

13. The method claim 12 wherein the step of destaining comprises:
washing the gel with water.

14. The method of claim 12 wherein the step of destaining comprises:
washing the gel with a destaining solution containing potassium chloride (KCl) in deionized water.

15. The method of claim 1 comprising the further step of recovering the separated protein fraction(s) for further processing, purification or analysis.

16. The method of claim 15 comprising subjecting the separated protein fraction(s) to further processing, purification, or analysis

17. A running buffer composition for gel electrophoresis comprising:
a fluorescent dye in an aqueous buffered solution having a concentration of detergent less than 0.10% (v/v).

18. The running buffer of claim 17 wherein the aqueous buffered solution is an aqueous solution of 0.025 M Tris (tris(hydroxy methyl)amino-methane) and 0.192 M glycine at about pH 8.3.

19. The running buffer of claim 18 wherein the concentration of detergent is 0.05% (v/v)

20. The running buffer composition of claim 17 of claim 1 wherein the fluorescent dye is selected from the group consisting of Nile red, CAS# 7385-67-3, also known as 9-diethylamino-5H-benzo(α)phenoxazine-5-one). and Phosphine dyes.
